(19) United States
(12) Patent Application Publication
(10) Pub. No.: US 2017/0177994 A1
(43) Pub. Date: Jun. 22, 2017

(54) APARATUS FOR ANALYZING A TIME INTERVAL BETWEEN TWO EXCITATIONS

(71) Applicant: MARTIN SALINGA, AACHEN (DE)

(72) Inventor: MARTIN SALINGA, AACHEN (DE)

(21) Appl. No.: 15/116,410

(22) PCT Filed: Feb. 5, 2015
(86) PCT No.: PCT/EP2015/052420

§ 371 Date: Aug. 3, 2016

(30) Foreign Application Priority Data
Feb. 5, 2014 (DE) 10 2014 202 107.3

(51) Int. Cl. G06N 3/08; G06N 3/063

(52) U.S. Cl. CPC G06N 3/08; G06N 3/0635

(57) ABSTRACT

The present invention relates to a device for the evaluation of a time interval between two excitations, comprising at least one excitable material that can be brought, at least partially, into an excited state by means of an excitation, whereby the excitability of the material that is in this excited state changes over time. Furthermore, the present invention also relates to a method for the evaluation of a time interval between two excitations, to the use of a device according to the invention, as well as to an artificial neural network comprising at least one device according to the invention.

The present invention relates to a device for the evaluation of a time interval between two excitations, comprising at least one excitable material that can be brought, at least partially, into an excited state by means of an excitation, whereby the excitability of the material that is in this excited state changes over time. Furthermore, the present invention also relates to a method for the evaluation of a time interval between two excitations, to the use of a device according to the invention, as well as to an artificial neural network comprising at least one device according to the invention.

The ability of the human brain to learn resides especially in the connections between neurons, which are called synapses. With every activity of the brain, information in the form of electrical impulses is transmitted from one neuron to another. It is also said that the neurons are “firing”. During the learning process, this transmission of signals can be practiced and improved.

In this context, a synapse is a connection site via which a neuron is in contact, for example, with another neuron, a receptor cell, a muscle cell or an endocrine cell. Synapses serve to transmit impulses or signals, and they also allow the modulation of the impulse or else signal transmission, in addition to which they can store information and contribute to learning through the modality of adaptive changes.

Thus, a synapse can be, for example, a connection site between an axon of a neuron and the dendrites of another neuron. These two neurons, which are connected by a synapse, are then referred to as presynaptic and postsynaptic, respectively.

When a first neuron (presynaptic neuron) emits an impulse (pre-impulse) that causes another impulse (post-impulse) to be emitted in a second neuron (postsynaptic neuron), it can be useful to improve the contact between these two neurons.

This applies especially if there is an association between the impulse of the first neuron and the response impulse of the second neuron. Such an association exists, for instance, if both impulses arrive at a synapse within a short time interval. This would indicate that there is a correlation between the impulses. In this case, it then makes sense to improve the contact of these neurons via this synapse.

If there is no such association, then the contact can preferably be weakened or worsened.

This behavior is called “spike-timing dependent plasticity” (STDP) and it causes certain connections between neurons to be improved if they are often relevant or often needed, whereas others that are less often relevant or less often needed might decline.

Consequently, this behavior also contributes significantly to the fact that the brain learns.

In recent times, the natural neural networks of the brain have also served as inspiration for so-called neuromorphic hardware. This is hardware that is structured on the basis of the example of natural neural networks.

In this context, it is a known approach in neuromorphic hardware to implement an STDP behavior by providing artificial synapses. Such an artificial synapse can also be implemented, for example, by means of a phase-change material.

A phase-change material can change from one phase to another phase (for instance, from an amorphous phase to a crystalline phase or from a crystalline phase to an amorphous phase) as a result of an impulse whose voltage exceeds a certain threshold value, thereby changing its resistance.

Consequently, phase-change materials known from the state of the art can be used in artificial synapses, first of all, in order to achieve a change in the weight of artificial synapses and thus to improve the connection between two artificial neurons by reducing the resistance of the phase-change material, or else to worsen it by increasing the resistance of the phase-change material. The weight of an artificial synapse can refer especially, for example, to the strength or to the quality of a connection established by a synapse.

Moreover, an STDP behavior could also be implemented in the state of the art. For this purpose, however, two impulses from neurons arriving at a synapse have to be coordinated in such a way—especially in terms of their timing—that only if both impulses are suitably superimposed can they together bring about a change in the resistance of the phase-change material employed. Here, one of the impulses (as a rule, for example, the impulse of the presynaptic neuron) can be selected to be relatively short. Depending on the timing or on the temporal coordination of the two impulses, by means of superimposition, this short impulse can select a portion of a further/a second/a longer impulse (as a rule, for example, the impulse of the postsynaptic neuron) arriving at the same synapse.

Only when the two impulses are superimposed does the applied voltage exceed the threshold value that is needed to trigger a phase change and to influence the resistance of the phase-change material. In this context, the other/the second/the longer impulse is configured such that the resistance of the employed phase-change material of the artificial synapse can be either reduced or increased, depending on the portion of this longer impulse in which it is superimposed with the short impulse. Thus, the connection could be improved or worsened by the artificial synapse as a function of the timing of the two impulses.

Therefore, in order to implement an STDP behavior with artificial synapses as described above and as is known from the state of the art, there is a need for a precise timing or a precise temporal coordination of the emitted impulses through the use of additional external electronics.

Moreover, the resistance of an artificial synapse should be reduced to the greatest extent possible in order to improve the thus enabled connection of artificial neurons if the second impulse arrives at the artificial synapse immediately after the first impulse since, in this case, an actual correlation between the two impulses is most probable.

However, this is not necessarily possible in the state of the art since a maximum change or reduction in the resistance according to the state of the art might only be possible once the shorter impulse has been superimposed over the center portion of the longer impulse. For this purpose, the shorter impulse might have to be appropriately delayed externally.

Due to a time delay of the emitted impulses, which could be necessary in order to achieve a suitable timing, artificial neurons then might not be able to emit an impulse precisely when this would be conducive for the functionality of an artificial neural network. Moreover, owing to appertaining system-related or method-related delays, the duration that is needed in order to change the artificial synapse is also prolonged. This can especially become problematic, for instance, if the highest possible processing speed or a high data throughput rate is desired.

Consequently, the maximum time interval between two impulses that can still bring about a change in the resistance of a phase-change material in an artificial synapse and therefore, an improvement or a worsening of the connection thus achieved is determined in the state of the art by the length of the longer of the two impulses. A change in the resistance can only take place when the two impulses are superimposed and therefore during the longer impulse. In fact, after the longer impulse, the impulses apparently can no longer be superimposed.

If the maximum time interval between two impulses that can still bring about a change in the resistance of a phase-change material in an artificial synapse is supposed to be within the range of milliseconds, as is the case in nature, then in order to emulate, for example, the behavior of a natural neural network or of a brain as precisely as possible and/or in order to process information or data that is obtained on time scales that are relevant for humans, according to the state of the art, the longer of the two impulses arriving at the synapse has to be relatively long and likewise has to be within the range of milliseconds.

Moreover, long impulses within the range of milliseconds are also problematic since this translates into a relatively high energy consumption.

Another problematic aspect is that external electronics that are needed in the state of the art for the timing of the impulses take up space. This can especially be problematic when a network, for example, with several thousand, tens of thousands, hundreds of thousands, millions or hundreds of millions or even several billion artificial synapses and artificial neurons, is being considered.

Consequently, there is a need to find a solution to these problems.

The present invention relates to a device for the evaluation of a time interval between two excitations according to claim 1, comprising at least one excitable material that can be brought, at least partially, into an excited state by means of an excitation, whereby the excitability of the material that is in this excited state changes over time.

Additional embodiments of the present invention given by way of example can be found in the subordinate claims and in the description.

The invention is based, on the one hand, on the fact that, when it comes to the conductance of electrically excitable amorphous semiconductor materials, they respond very non-linearly to electrical excitations generated by voltage signals. Often, as is also the case in amorphous phase-change materials, there is even a sharp transition between poor conductance at low voltages and good conductance at high voltages. In such cases, one speaks of a so-called voltage threshold value at which the electric resistance abruptly sags. On the other hand, however, it is essential for the invention that this excitability (that is to say, preferably the voltage threshold value) is not a constant quantity but rather changes after a first excitation signal during the time in which the semiconductor material is in a state of low conductance (see FIG. 1).

If the second signal is higher than the voltage threshold value that has to be exceeded at this point in time, then the amorphous semiconductor material is excited into a temporarily more conductive state. In case of a signal whose strength is below the voltage threshold value, then the excitation is absent and the amorphous semiconductor material remains unchanged at a low conductance.

Due to the fact that the voltage threshold value rises over time (see FIG. 1), the time difference between two signals can now be determined, and since it is associated with an electronically relevant material change, this time difference can also be used to model learning processes. By the same token that, in the case of nerve cells, the synaptic connection is strengthened by means of action potentials that follow each other in rapid succession, when it comes to the device according to the invention, the conductance of the amorphous semiconductor material is temporarily changed and can thus lead to a permanent change in a downstream memristive element.

A device according to the invention for the evaluation of a time interval between two excitations according to claim 1 can comprise at least one excitable material that can be brought, at least partially, into an excited state by means of an excitation, whereby the excitability of the material that is in this excited state changes over time.

A device according to the invention can comprise at least one excitable material that can be brought, at least partially, into a continuously excited state by means of an excitation, whereby the excitability of the material that is in this excited state changes over time.

An excitation can especially be, for example, an electrical excitation. Consequently, the term “excitability” can refer, for instance, to electrical excitability.

An excitation could be generated, for instance, by means of electrical excitation, by means of electromagnetic radiation or by means of heating or else by reaching a certain temperature.

An excitable material can be, for example, an excitable semiconductor material and/or an electrically excitable material or an electrically excitable semiconductor material which, by means of electricity or by means of electrical excitation, can be brought, at least partially, into a certain state or into a material state, especially, for instance, into an excited or amorphous state. An excited or amorphous or semi-crystalline state can be an excited and especially an amorphous or semi-crystalline state. A semi-crystalline state can be, for instance, a state in which the material is only incompletely crystallized. Therefore, such a state can also be incompletely amorphous. A state could, for example, also affect only a portion of such a material, especially a portion of the material that is directly adjacent to an electrode (that can be used to apply an excitation or a signal). In this state, the excitability or the electrical excitability of the material can change over time. This can mean, for instance, that the excitability or the electrical excitability of the material changes over time due to a further/a later excitation or electrical excitation in the excited state, which can especially be an amorphous state. The fact that the excitability changes over time can mean, for example, that the further excitability changes over time or as the time passes after a first excitation, especially by means of a first/an earlier signal.

An excitable material, for example, especially an excitable semiconductor material and/or an electrically excitable material or an electrically excitable semiconductor material can be brought, at least partially, into a certain state or material state, especially, for example, into an excited or amorphous state. This can mean, for example, that at least a portion of the material can be brought into a certain state or material state, especially, for instance, into an excited or amorphous state.

Accordingly, a device according to the invention for the evaluation of a time interval between two excitations can especially comprise, for example, at least one electrically excitable semiconductor material that can be brought into an amorphous state by means of an excitation, especially by means of an electrical excitation, whereby the electrical excitability of the semiconductor material that is in this amorphous state changes over time.

An electrical excitation can be achieved, for example, by means of at least one electrical impulse/pulse or by means of at least one electric signal. In this context, the electric current strength, the electric voltage and/or the duration of an impulse/pulse or signal used for the excitation can be varied. Thus, a signal or an impulse/pulse or else an electric signal or an electrical impulse/pulse can constitute an excitation.

A certain electric current strength and/or a certain electric voltage can be used, for instance, to achieve an electrical excitation.

A certain state or material state into which the excitable material or the semiconductor material can be brought by means of an excitation or by means of an electrical excitation can be, for example, an excited state, especially an amorphous state, a semi-crystalline state, an energetically higher state and/or an electronically excited state, an electrically less conductive state or an electrically more conductive state. In this context, an excited state can also be, for instance, a state in which at least a portion of the employed excitable material or of the excitable semiconductor material can be in an amorphous, a semi-crystalline state, an energetically higher state and/or an electronically excited state, an electrically less conductive state or an electrically more conductive state. An excited state can also be, for instance, a temporary or non-continuous state that can only be achieved or can only continue in the presence of constant excitation or for the duration of an excitation. This can especially apply if an excited state is, for instance, an energetically higher state and/or an electronically excited state, an electrically less conductive state or an electrically more conductive state. As an alternative, for example, an excited state can also be continuous or it can be a continuous state that, after excitation or electrical excitation, can continue or can remain excited at least for some time, especially, for instance, during the relaxation time. This can especially be the case if an excited state is, for instance, an amorphous or semi-crystalline state. Consequently, a continuous excited state can change only relatively slowly, especially until a further excitation or a further signal, and can remain in an excited state that could be changing during the relaxation time. Optionally, a return to a non-excited state could only take place after that.

The fact that the excitability or the electrical excitability of the excitable material or of the excitable semiconductor material changes over time can mean, for example, that the ability of the excitable material or of the excitable semiconductor material to be brought into a certain material state by means of a certain excitation or by means of an electrical excitation changes over time. This can especially mean, for instance, that the excitability or the electrical excitability in this state decreases or increases over time. Here, the excitability or the electrical excitability can preferably decrease over time. Consequently, the excitability can be the ability to change the excitable material or the excitable semiconductor material, especially, for instance, also by means of a further excitation or a further electrical excitation.

In this context, an excitable material or an semiconductor material can be continuously brought, at least partially, from a crystalline, semi-crystalline or amorphous state, for example, into a different excited amorphous or semi-crystalline state by means of a (first/earlier) excitation or electrical excitation. Over time, this changes the electrical excitability of the excitable material or of the semiconductor material that is in the excited or amorphous or semi-crystalline state into which it had been brought by means of the electrical excitation.

Due to the change in the excitability as time passes, it can always become more and more difficult for the material or the semiconductor material, especially an amorphous or semi-crystalline material or a semiconductor material that had already been excited by means of a first/an earlier excitation, to be brought, for example, electrically (by means of a second/a further/a later excitation or electrical excitation), at least partially, into another state or material state, namely, especially, for instance, into an electrically more conductive state. Thus, for example, a change in the amorphous or semi-crystalline material or in the semiconductor material can either still take place or not, as a function of the lapsed time, by means of a second/a further/a later excitation, especially by means of a second/a further/a later electrical excitation.

The probability of being able to trigger a change in the excited or amorphous or semi-crystalline material or in the semiconductor material with a second/a further/a later excitation can decrease over time, if the excitability, especially the electrical excitability, decreases over time. This applies especially, for example, if the second/the further excitation does not change over time.

A second/a further/a later excitation or a second/a further/a later electrical excitation or a signal employed for the excitation or a second/a further/a later signal can be a signal that is applied to an excited material or to an amorphous material or to an amorphous semiconductor material that had been brought, at least partially, into an excited or amorphous state by means of a first/an earlier excitation or by means of a first/an earlier signal. A second/a further/a later excitation or a second/a further/a later electrical excitation or a signal employed for the excitation or a second/a further/a later signal, for instance, might not change over time or during the excitation or the signal. A second excitation or a second signal can be, for instance, a further/a later excitation or a further/a later signal that can follow at least a first/an earlier excitation or at least a first/an earlier signal. In this context, a first excitation or a first signal can be, for instance, an earlier excitation or an earlier signal that takes place, for instance, before a second/a further/a later excitation or a second/a further/a later signal.

Thus, it could be possible to evaluate how much time has passed between a first/an earlier excitation and a second/a further/a later excitation or else between the arrival of a first/an earlier signal (reset pulse) and the arrival of a second/a further/a later signal. Consequently, the time interval between the two excitations or signals can be evaluated in order to implement an STDP behavior that could be based upon this.

An excitable material or an excitable semiconductor material according to the invention can be, for instance, a material in which a phase change can be effectuated by means of an electrical excitation. Such a phase change could also take place relatively slowly and could continue, for example, for more than 1 μs, preferably more than 5 μs, even more preferably more that 10 μs.

For materials in which a phase change takes place relatively slowly, the state or the material state, for example, can be set more precisely by means of an excitation, especially by means of an electrical excitation, so that more possibilities could be attained in order to be able to influence the resistance of such materials.

As a result, through an evaluation of the time interval between two excitations or between two signals, for example, a gradual STDP behavior could be achieved in which the shorter the time interval between the two signals is, the greater the extent to which the resistance of an artificial synapse is reduced, and/or the longer the time interval between the two signals is, the greater the extent to which the resistance of an artificial synapse is increased. In contrast to this, the use of materials in which a phase change takes place relatively quickly can lead to a situation in which, by evaluating the time interval between two excitations or between two signals, an STDP behavior could be achieved in which the resistance of an artificial synapse is reduced if the time interval between two signals is below a threshold value for the time interval, and/or the resistance of an artificial synapse is increased if the time interval between two signals is above a threshold value for the time interval.

An excitable material or a material with which a phase change can be effectuated by means of an electrical excitation can make a transition, for example, by means of an electrical excitation, especially from an amorphous or semi-crystalline state to a crystalline or another semi-crystalline state and/or from a crystalline or semi-crystalline state to an amorphous or another semi-crystalline state and/or from an electrically less conductive, excited or amorphous or semi-crystalline state to an electrically more conductive state and/or from an electrically more conductive state to an electrically less conductive state. Therefore, a semiconductor material employed according to the invention can be, for instance, a phase-change material that can be brought into an amorphous or semi-crystalline state by means of a first/an earlier electrical excitation. Moreover, a material in which a phase change can be effectuated by means of an electrical excitation, or else a phase-change material that is in the excited or amorphous state can be brought from an electrically less conductive amorphous state into an electrically more conductive state by means of a second/a further/a later excitation or electrical excitation.

A material in which a phase change can be effectuated by means of an electrical excitation or else a phase-change material can be brought, at least partially, into an amorphous or semi-crystalline state by means of an electrical excitation through the modality of the application of a voltage. For example, a short signal at a high voltage or a high current strength can be used for this purpose. In this manner, the material can be at least partially heated up and quickly cooled off again. As a result, for example, in an area directly adjacent to an electrode, the above-mentioned material or semiconductor material could be continuously brought into an amorphous or semi-crystalline state that can have a higher electric resistance, especially, for instance, in comparison to a first/a previous state. In this context, the electrode can especially be, for example, an electrode that can be used to apply an excitation or a signal to a device according to the invention. Here, the term “continuously” can especially refer to, for example, a state that has been achieved by a change in the crystalline state of the material and/or a state that is changing only relatively slowly, at least until a further excitation or until a further signal. This can be effectuated by means of a signal or by means of a first/an earlier signal according to the invention that can be called, for example, a reset pulse. This can be considered, for instance, as an initialization of a device according to the invention. The duration, the voltage and the current strength of the signal used for this purpose can be selected or set here, for example, as a function of the employed material and/or of the connection/the arrangement/the incorporation of a device according to the invention and/or of a connected memristive element, for example, in an artificial neural network and/or in another circuit.

Moreover, in this context, when a certain voltage is applied that exceeds a voltage threshold value, a material in which a phase change can be effectuated by means of an electrical excitation or else a phase-change material can be brought from an excited or amorphous or semi-crystalline less conductive state, at least partially, into an electrically more conductive state that can have a lower electric resistance, especially, for instance, in comparison to a first/a previous state. This electrically more conductive state can also be a temporary or non-permanent state that can only be achieved in case of continuous excitation or else for the duration of a signal. The expression “brought, at least partially, into a state” can mean, for example, that at least a portion of a material, and especially at least a portion of the material that is directly adjacent to an electrode, is bought into this state. In this context, the electrode can especially be, for example, an electrode that can be used to apply an excitation or a signal to a device according to the invention. Here, a less conductive state or a more conductive state can refer to at least a portion of such a material and especially to at least a portion of this material that is directly adjacent to an electrode (that can be used to apply an excitation or a signal to a device according to the invention). This can be effectuated by means of a signal or by means of a second/a further/a later signal according to the invention. The duration, the voltage and the current strength of the signal used for this purpose can be selected or set here, for instance, as a function of the employed material and/or of the connection/the arrangement/the incorporation of a device according to the invention and/or of a memristive element connected to it, for example, in an artificial neural network and/or in another circuit.

The time needed for a change from an excited or amorphous or semi-crystalline less conductive state to an electrically more conductive state can depend here, for example, on the magnitude of the applied voltage. The higher the applied voltage is above the voltage threshold value, the more quickly a change can take place. The closer the applied voltage is to the voltage threshold value, the more slowly a change can take place. If a voltage is used that is close to the voltage threshold value, this could delay a change. In this context, an excitable material or an excitable semiconductor material employed according to the invention could integrate one or more signals that are above the voltage threshold value. This can mean, for example, that one signal or possibly several signals and/or several portions of signals that can lead to a change, when integrated, can contribute to such a change.

As a result, through an evaluation of the time interval between two excitations or between two signals, a device according to the invention could also contribute, for instance, to the fact that a gradual STDP behavior can be implemented in which the shorter the time interval between the two signals is, the greater the extent to which the resistance of an artificial synapse is reduced, and/or the longer the time interval between the two signals is, the greater the extent to which the resistance of an artificial synapse is increased.

In this context, the voltage threshold value of the material in which a phase change can be effectuated by means of an electrical excitation or the voltage threshold value of the phase-change material that is in the excited or amorphous or semi-crystalline state into which it had been brought, at least partially, by means of an excitation or an electrical excitation can change over time. In this context, one also speaks of a drift of the voltage threshold value of the material or of the semiconductor material. Here, the voltage threshold value can especially increase or decrease over time. Preferably, the voltage threshold value can, for example, increase over time. Owing to this change in the voltage threshold value over time, the excitability or the electrical excitability of the material that is in the excited or in the amorphous state changes. Here, the electrical excitability can decrease over time if the voltage threshold value increases over time.

In fact, owing to the drift of the voltage threshold value as time passes, it can become more and more difficult for the material that had already been excited by means of a first/an earlier electrical excitation or for the amorphous or semi-crystalline material, to be brought, at least partially, for example, electrically, into another specific material state, namely, for instance, a crystalline state or another semi-crystalline state having a higher or a lower resistance. Thus, as a function of the lapsed time, a change in the amorphous material by means of a second/a further/a later electrical excitation can either still take place or not.

The probability of being able to trigger a change with a second signal according to the invention can decrease, for instance, over time, if the voltage threshold value increases over time. Thus, it could be evaluated how much time has passed between the arrival of a first/an earlier signal (reset pulse) and the arrival of a second/a further/a later signal. The time interval between the two signals can be evaluated accordingly.

In this manner, it could be evaluated how much time has passed between the arrival of a first/an earlier signal (reset pulse) and the arrival of a second/a further/a later signal. The time interval between the two excitations or signals can be evaluated accordingly in order to implement an STDP behavior that could be based upon this.

In one embodiment of a device according to the invention for the evaluation of a time interval between two excitations or two signals, the device can be configured, for instance, in such a way that an electrically excitable semiconductor material can be continuously brought, at least partially, into an amorphous state by means of a first/an earlier signal, whereby the electrical excitability of the semiconductor material that is in the excited or amorphous state changes over time, and the semiconductor material that is in this excited or amorphous state can be temporarily caused to change, at least partially, from an electrically less conductive state to an electrically more conductive state by means of a second/a further/a later signal, whereby moreover, the change takes place as a function of the change in the excitability of the semiconductor material that is in the excited or amorphous state.

The expression “brought, at least partially, into a state” can mean, for example, that at least a portion of a material, and especially at least a portion of the material that is directly adjacent to an electrode, is bought into this state. In this context, the electrode can especially be, for example, an electrode that can be used to apply an excitation or a signal to a device according to the invention. Here, an excited or amorphous and/or a more conductive state or a less conductive state can refer to at least a portion of such a material and especially at least to a portion of this material that is directly adjacent to an electrode. This electrode can especially be, for instance, an electrode that can be used to apply an excitation or a signal to a device according to the invention.

In this context, an excitable semiconductor material can especially be, for instance, a phase-change material or a material in which a phase change can take place.

As time passes, it could become more difficult and/or easier to trigger a change with a second/a further/a later signal according to the invention. The probability of being able to trigger a change with a second/a further/a later signal according to the invention can decrease, for example, over time if the excitability decreases over time.

Thus, it could be possible to evaluate how much time has passed between the arrival of a first/an earlier signal (reset pulse) and the arrival of a second/a further/a later signal. Accordingly, the time interval between the two signals can be evaluated.

According to the invention, the employed excitable material or the electrically excitable semiconductor material that is in the excited or amorphous or semi-crystalline state can be caused to change, at least partially, from an electrically less conductive state to an electrically more conductive state by means of a second/a further/a later signal. In this context, a change can be effectuated, at least partially, from any electrically less conductive amorphous or semi-crystalline state to any other more conductive state by means of a second/a further/a later signal.

Here, according to the invention, a change takes place as a function of the change in the excitability of the material or of the semiconductor material that is in the excited or amorphous or semi-crystalline state only insofar as the electrical excitability has not changed so markedly during the time interval between the first/the earlier signal and the second/the further/the later signal that, as a result, the second/the further/the later signal is no longer sufficient for an excitation or is no longer sufficient to cause the material or the semiconductor material that is in the excited or amorphous or semi-crystalline state to change, at least partially, from an electrically less conductive state to an electrically more conductive state by means of a second/a further/a later signal.

The time interval during which the precondition still exists for a change of the semiconductor material that is in the excited or amorphous or semi-crystalline state from a less conductive state into a more conductive state by means of a second/a further/a later signal according to the invention can depend, for example, on the employed material or semiconductor material and/or on the temperature and/or on the employed excitation(s) or on the employed signal(s).

As set forth in the invention, an electrically less conductive state can be, for instance, a state or any state that, in contrast to an electrically more conductive state, has a measurably higher resistance. In this context, an electrically less conductive state can especially be, for instance, a state or any state that, in contrast to an electrically more conductive state, has a resistance that is higher by one order of magnitude, preferably by two orders of magnitude, also preferably by three orders of magnitude, further preferably by four orders of magnitude, especially preferably by five orders of magnitude.

Accordingly, the time interval between two signals arriving at the device can be easily and readily evaluated by means of a device according to the invention, for example, in order to ascertain whether this time interval exceeds a certain value. Thus, for instance, it can be readily ascertained whether there is a correlation between two signals so as to implement an STDP behavior that could be based upon this.

In a device according to the invention, an employed excitable material or an excitable semiconductor material or an electrically excitable semiconductor material can comprise at least one element from Groups III and/or IV A and/or V A and/or VI A of the periodic table.

In one embodiment of a device according to the invention, an excitable material or an excitable semiconductor material or an electrically excitable semiconductor material can comprise, for example, at least a chalcogenide, especially an amorphous chalcogenide and/or a chalcogenide that has been modified, for example, by substitution and/or doping.

In one embodiment of the device according to the invention, an excitable material or an excitable semiconductor material or an electrically excitable semiconductor material can be selected, for example, from the group comprising the following materials by way of example: Ge₂Sb₂Te₅, Ag₅In₅Sb₆₀Te₃₀, GeTe, GeTe₆, GeSb, GaSb.

In this manner, materials or semiconductor materials can be obtained that have suitable material properties, especially, for example, in terms of their electrical excitability and/or in terms of a possible change from an amorphous less conductive state to an electrically more conductive state by means of a suitable electrical excitation or possibly by means of a second signal according to the invention.

In one embodiment of a device according to the invention, an excitable material or an excitable semiconductor material or an electrically excitable semiconductor material can be, for example, a phase-change material (PCM) that can be excited, for instance, by means of an electric voltage, whereby the phase-change material that is in the excited or amorphous state can be excited by means of a voltage that is above a voltage threshold value, whereby the voltage threshold value of the phase-change material that is in the amorphous state, and thus the electrical excitability of this material, changes over time.

In this context, a phase-change material that is in the amorphous or semi-crystalline state can be caused to change from this electrically less conductive amorphous or semi-crystalline state to an electrically more conductive state by means of an electric signal. Here, a continuous change from any electrically less conductive amorphous or semi-crystalline state to any electrically more conductive crystalline or other semi-crystalline state can be effectuated by means of an electric signal.

On the other hand, a phase-change material that is, for example, in the crystalline or semi-crystalline state, can be caused to change from an electrically more conductive crystalline or semi-crystalline state to a less conductive amorphous or other semi-crystalline state by means of an electric signal. Here, a continuous change from any electrically more conductive crystalline or semi-crystalline state to any electrically less conductive amorphous or other semi-crystalline state can be effectuated by means of an electric signal.

A phase-change material (PCM) can especially comprise, for example, an amorphous chalcogenide and/or a chalcogenide that has been modified, for example, by substitution and/or by doping. A phase-change material (PCM) can also especially be, for example, a material with which a change from an amorphous less conductive state to a more conductive state can take place in less than 1 μs, preferably between 1 ns and 100 ns, especially preferably in less than 1 ns, when a voltage is applied that is above the voltage threshold value.

The time needed for a change can depend on the magnitude of the applied voltage. The higher the applied voltage is above the voltage threshold value, the more quickly a change can take place. The closer the applied voltage is to the voltage threshold value, the more slowly a change can take place. If a voltage is used that is close to the voltage threshold value, this could delay a change. In this context, an excitable material or an excitable semiconductor material employed according to the invention could integrate one or more signals that is/are above the voltage threshold value.

Through the use of a phase-change material (PCM), for example, especially a fast change can take place. In this manner, the signals that have to be processed can follow each other, for instance, in more rapid succession. Thus, a high processing speed or a high data throughput rate could be achieved in this manner.

In one embodiment of a device according to the invention, the device can be connected, for example, electrically, to at least one memristive element in order to control access to it.

A memristive element can especially be, for example, any element that has an electrically changeable resistance. A memristive element can especially comprise, for instance, a phase-change material. In fact, such materials can be brought, for example, by means of at least one electric signal, from at least an amorphous or semi-crystalline state having a higher resistance, especially, for example, continuously, into at least a crystalline or another semi-crystalline state having a lower electric resistance, or else from at least a crystalline or another semi-crystalline state having a lower resistance, especially, for example, continuously, into an amorphous or another semi-crystalline state having a higher resistance. Thus, a phase-change material can be an example of a memristive element.

Additional examples of a memristive element can comprise, for example, a Pt/TiO₂/RiO₂₋ₓ/Pt layer arrangement and/or an “Ag in Si” layer (see Nano Lett. 2010, 10, 1297-1301), since the resistance of such layers and/or elements is likewise electrically changeable. A Pt/TiO₂/RiO₂₋ₓ/Pt layer arrangement and/or an “Ag in Si” layer can thus likewise be examples of a memristive element.

A memristive element can be connected, for example, in series and/or in parallel to a device according to the invention.

A device according to the invention is preferably arranged, for example, in such a way that it controls access to at least one memristive element. For this purpose, a device according to the invention could be connected to a memristive element in a suitable manner.

The fact that a device according to the invention controls access to a memristive element that is connected to it can mean, for example, that a device according to the invention regulates the resistance that has to be overcome in order to be able to access a memristive element or possibly to electrically change its resistance. This can especially be the case, for instance, if a device according to the invention is connected in series to a memristive element, whereby its access can be controlled by the device. Here, a change in the resistance of a memristive element can, for example, be made possible and/or can be simplified if the resistance of a device according to the invention is reduced or if the time interval between two excitations or two signals is below a certain value. In contrast to this, a change in the resistance of a memristive element can be, for example, prevented or made more difficult, if the resistance of a device according to the invention is increased or remains unchanged at a high level, or else if the time interval between two excitations or two signals is above a certain value.

The fact that a device according to the invention controls access to a memristive element that is connected to it can mean, for example, that a device according to the invention controls access to a memristive element that is connected to it, for example, via/by means of a transistor, whereby the resistance of a transistor and/or the portion/the current (for example, the current strength and/or the voltage and/or the duration) of a second signal that is allowed to pass through via/by means of the transistor can be changed as a function of a device according to the invention or as a function of the portion/current (for example, the current strength and/or the voltage and/or the duration) of a second signal that is allowed to pass through via/by means of the device according to the invention. A transistor can be connected upstream or downstream from the memristive element. The transistor can also be configured in such a way that at least a portion of each excitation or of each signal is allowed to pass through (“leaky transistor”).

In this manner, a change in the resistance of a memristive element can, for instance, be made possible and/or can be simplified if, for example, the resistance of a device according to the invention is reduced or if the time interval between two excitations or two signals is below a certain value.

As an alternative, a change in the resistance of a memristive element can, for example, be made possible and/or can be simplified if the resistance of a device according to the invention is increased or remains at a high level. Here, a change in the resistance of a memristive element can, for example, be prevented and/or made more difficult, if the resistance of a device according to the invention is reduced. The resistance of a device according to the invention can then remain at a high level or can be increased if the time interval between two excitations or two signals is too long/too great, so that the second excitation or the second signal can still temporarily bring, at least partially, the excited material or the amorphous semiconductor material from an electrically less conductive state into an electrically more conductive state. This can especially be the case, for instance, if a device according to the invention is connected/interconnected in parallel to a memristive element and whose access to it can be controlled by the device.

In this manner, increasing or reducing the resistance of an artificial synapse could be made possible by a change in the electric resistance of the memristive element in order to improve or else to worsen the connection by means of this artificial synapse or in order to change its synaptic weight and thus to implement an STDP behavior as a function of the temporal correlation between the excitations or electrical excitations. Here, an example of an artificial synapse can be a device that can mimic the behavior of a natural synapse. In this context, an artificial synapse according to the invention can especially comprise at least one device according to the invention for the evaluation of a time interval between two signals.

In the case of a memristive element comprising a phase-change material, a reduction in the resistance can be effectuated, especially, for example, continuously, by means of a change from an amorphous or semi-crystalline state into which, during a reset, the memristive element was brought into a more conductive crystalline state or into another more conductive semi-crystalline state, especially, for instance, if a second excitation or a second signal arrives at or is applied to a device according to the invention within a certain time interval. Moreover, a reduction in the resistance, especially, for example, also continuously, can be effectuated by means of a change from a semi-crystalline or crystalline state into which, during a set, the memristive element was brought into a more conductive other crystalline state or into another more conductive semi-crystalline state, especially, for instance, if a second excitation or a second signal arrives at or is applied to a device according to the invention within a certain time interval.

In the case of a memristive element comprising a phase-change material, an increase in the resistance can be effectuated, especially, for example, continuously, by means of a change from a crystalline or semi-crystalline state into which, during a set, the memristive element was brought into a less conductive amorphous state or into another less conductive semi-crystalline state, especially, for instance, if a second excitation or a second signal does not arrive at or is not applied to a device according to the invention within a certain time interval. Moreover, an increase in the resistance can be effectuated, especially, for example, also continuously, by means of a change from a semi-crystalline or crystalline state into which, during a set, the memristive element was brought into a less conductive other crystalline state or into another less conductive semi-crystalline state, especially, for instance, if a second excitation or a second signal does not arrive at or is not applied to a device according to the invention within a certain time interval.

A reset and/or a set of a memristive element can be effectuated by means of a portion of a first/an earlier signal according to the invention and/or by means of a portion of a second/a further/a later signal according to the invention that reaches a memristive element via/by means of a device according to the invention. Preferably, a set can be effectuated, for example, by means of a second signal and/or by means of a portion thereof. In particular, a change in the state of the material can be triggered, for instance, by means of a second signal and/or by means of a portion thereof. In this case, the set pulse can be, for example, the second signal and/or a portion thereof.

In one embodiment, a portion of a second signal according to the invention that, via/by means of a device according to the invention, reaches a memristive element that is connected to it and whose access is controlled by the device, can in any case lead to a slight increase in the resistance of this memristive element, for example, through a certain amorphization, if the second signal arrives too late at a device according to the invention to make a temporary change to a more conductive state possible. This can be made possible, for example, by a waveform for a second signal in which a longer square-wave pulse having a lower maximum (in terms of current strength and/or voltage) merges into a shorter, immediately subsequent square-wave pulse having a higher maximum (in terms of current strength and/or voltage). The first square-wave pulse of such a signal can temporarily bring, at least partially, for instance, the material or the semiconductor material employed in a device according to the invention from an excited or amorphous less conductive state into a more conductive state if the second signal still arrives at the device according to the invention within a certain time interval. The entire appertaining signal and/or the first portion/square-wave pulse of such a signal can then continuously bring, at least partially, for example, a memristive element that is connected to the device according to the invention and whose access is controlled by the device or else a phase-change material that could be employed in the device according to the invention into a more conductive crystalline or semi-crystalline state. Consequently, this can especially be the case if the first portion/square-wave pulse of such a signal still arrives at a device according to the invention within a certain time interval, so that the material or the semiconductor material employed in a device according to the invention can still be temporarily brought, at least partially, from an excited or amorphous less conductive state into a more conductive state. Otherwise (if the second signal or a portion thereof arrives later), only the second portion/square-wave pulse of the second signal could still temporarily bring a material that is provided in a device according to the invention and that has already been excited by means of a first signal from a less conductive state into a more conductive state. Consequently, only the second portion/square-wave pulse of the second signal could still reach the excitable material or a memristive element that is connected to the device according to the invention and whose access is controlled by the device. A memristive element that is connected to the device according to the invention and whose access is controlled by the device or else a phase-change material that is employed in the device according to the invention could then be continuously brought, at least partially, into a less conductive amorphous or semi-crystalline state by means of this second portion/square-wave pulse of such a signal, especially, for example, through a certain amorphization.

A phase-change material can be continuously brought, at least partially, from an amorphous or semi-crystalline state into a more conductive other semi-crystalline state or into a less conductive other semi-crystalline state or into a more conductive crystalline state by means of an electrical excitation through the modality of the application of a voltage. For example, a relatively short signal at a high voltage or a high current strength or else a longer signal at a lower voltage or a lower current strength can be used for this purpose. In the former case, the material can be at least partially heated and cooled off again quickly in order to achieve an amorphization or partial amorphization. In the latter case, the material can thus be at least partially heated up slowly and cooled off again slowly in order to achieve a crystallization or partial crystallization.

In this manner, the above-mentioned material or semiconductor material, for example, could be continuously brought, at least partially, into a state that can have a higher or lower electric resistance, especially, for example, in comparison to a first/an earlier state. This can be effectuated by means of a signal or by means of a first/an earlier signal according to the invention that can be referred to, for example, as a reset pulse. This can be considered, for instance, as an initialization of a device according to the invention. An at least partially amorphous state could have a higher resistance. An at least partially crystalline state, in turn, could have a lower resistance. The term “brought, at least partially, into a state” can mean, for example, that at least a portion of a material, and especially at least a portion of a material that is directly adjacent to an electrode, is bought into this state. In this context, the electrode can especially be, for instance, an electrode that can be used to apply an excitation or a signal to a device according to the invention. Here, a state having a higher or lower resistance can refer to at least a portion of such a material and especially to at least a portion of this material that is directly adjacent to an electrode (that can be used to apply an excitation or a signal to a device according to the invention).

In one embodiment, a portion of a first signal according to the invention and/or a portion of a second signal according to the invention that reaches the memristive element via/by means of a device according to the invention can lead to a reduction in the resistance of a memristive element, for example, through a certain crystallization, especially if the second signal arrives at a device according to the invention within a certain time interval after the first signal. For this purpose, the signals/the pulses have to be appropriately selected or set, especially, for instance, as a function of the excitable material employed for the device according to the invention, depending on the material employed for the memristive element, and/or on the temperature and/or on the connection/the arrangement/the incorporation of a device according to the invention and/or on a memristive element connected to it, for example, in an artificial neural network and/or in another circuit.

In one embodiment, a portion of a first signal according to the invention and/or a portion of a second signal according to the invention that reaches the memristive element via/by means of a device according to the invention can lead to an increase in the resistance of a memristive element, for example, through a certain amorphization, especially if the second signal does not arrive at a device according to the invention within a certain time interval after the first signal. For this purpose as well, the signals/the pulses have to be appropriately selected or set, especially, for instance, as a function of the excitable material employed for the device according to the invention, depending on the material used for the memristive element, and/or on the temperature and/or on the connection/the arrangement/the incorporation of a device according to the invention and/or on a memristive element connected to it, for example, in an artificial neural network and/or in another circuit.

The longer the time interval between two signals, the higher the voltage threshold value that has to be reached and the lower the current and/or the load that could be available to change the weight of an artificial synapse through an increase or reduction in the resistance of a memristive element, for example, in order to respectively worsen or improve a connection established by the artificial synapse. According to the invention, the term “two signals”, for example, refers to a first/an earlier and to a second/a further/a later signal.

Here, the interconnection of a device according to the invention and a memristive element that is connected to it and whose access is controlled by it makes it possible for at least a portion of each excitation or of each signal that arrives at or is applied to a device according to the invention to arrive at a device according to the invention as well as at the memristive element that is connected to it and whose access is controlled by it.

In this context, the interconnection of a device according to the invention and a memristive element that is connected to it and whose access is controlled by it could ensure, for example, by providing a resistance, that the first/the earlier signal has the least possible influence on the memristive element and, if at all possible, does not lead to a change here, especially to a continuous change. For this purpose, the employed excitable material and/or the employed phase-change material and/or the employed memristive element and/or the temperature and/or the first signal and/or the connection/the arrangement/the incorporation of a device according to the invention and/or of a connected memristive element can be suitably selected or set, for example, in an artificial neural network and/or in another circuit.

As a result, a device according to the invention that is connected to a memristive element in order to control access to it can be used, for example, as an artificial synapse in which the synaptic weight can be readily influenced by means of a change in the resistance of a memristive element that is connected to a device according to the invention.

As an alternative for providing a memristive element, a phase-change material, which is employed in a device according to the invention as an excitable material or else as a material in which a phase change can take place and which is employed in a device according to the invention as an excitable material could also be used to change the weight of a device according to the invention that is employed either as an artificial synapse or else in/with an artificial synapse, without changing a memristive element that is connected to it and that is otherwise autonomous. In such a case, this could be effectuated by means of a continuous change in the electric resistance of the phase-change material employed in a device according to the invention, for example, by means of a first/an earlier signal according to the invention and/or by means of a second/a further/a later signal according to the invention.

For this purpose, for example, only a small portion of the employed phase-change material or of the employed material in which a phase change can take place and which is directly adjacent to an electrode can be changed by means of the first signal, while a portion of the employed phase-change material or of the employed material in which a phase change can take place and which is no longer directly adjacent to the electrode can be changed by means of a second signal. Here, the electrode can especially be, for example, an electrode that can be used to apply an excitation or a signal to a device according to the invention.

In this manner, the weight of a device according to the invention that can be employed especially, for example, either as an artificial synapse or else in/with an artificial synapse can be changed, even without a memristive element that is connected to it and that is otherwise autonomous, and it can be readily influenced as a function of the time interval between two signals in order to implement an STDP behavior.

In one embodiment of a device according to the invention, a device according to the invention can comprise at least one heating element and/or cooling element. As a result, the change in the excitability of the employed excitable material can be set or accelerated or slowed down as a function of the temperature. At a higher temperature, the change can be, for example, accelerated. In contrast to this, the change in the excitability can be slowed down at a lower temperature. Here, the temperature can be changed, for example, for each individual device according to the invention, for one and/or more groups of at least two or more devices according to the invention and/or for all of the devices according to the invention together. As a result, a change in the excitable material or in the excitable semiconductor material that is in the excited or amorphous or semi-crystalline state from a less conductive state to a more conductive state by means of a second signal according to the invention can be made more difficult at an elevated temperature since the change of the excitability can be accelerated under these conditions, thereby reducing the time interval during which the precondition is still fulfilled for a change in the semiconductor material that is in the amorphous state from a less conductive state into a more conductive state by means of a second signal according to the invention. On the other hand, the appertaining time interval could be lengthened in case of a reduced temperature.

A device according to the invention could also be heated up without a separate or autonomous heating element, for example, by applying an electric current, whereby the electric voltage does not reach the voltage threshold value of the employed amorphous semiconductor material.

By means of an increased temperature, the time interval during which the precondition is still fulfilled for a change of the semiconductor material that is in the amorphous state from a less conductive state into a more conductive state by means of a second signal according to the invention could be changed for a device according to the invention in a learning mode. As a result, for example, the learning ability of an artificial synapse can be changed and/or a device according to the invention could even be brought into a processing mode in which the above-mentioned time interval is considerably shortened. In a processing mode, a change of the semiconductor material that is in the amorphous state from a less conductive state into a more conductive state by means of a second signal according to the invention should even be prevented, if at all possible, in order to permit data processing in which the resistance of an artificial synapse should not be changed, if at all possible.

In this manner, if necessary, a change in the resistance of an artificial synapse in the processing mode can be made more difficult (if at all possible, then only for a very short time interval between two signals) and/or completely prevented.

In one embodiment of the device according to the invention, such a device according to the invention can also comprise, for instance, at least one excitation generator or signal generator. As an alternative to this, an excitation generator or signal generator can also be provided, for example, for a group of two or more devices according to the invention and/or for all of the devices according to the invention. In this context, an excitation generator could be configured in such a way that, for example, it allows parameters such as the duration and/or the intensity of an excitation to be selected or influenced. A signal generator could be configured, for instance, in such a way, for example, that the voltage applied by means of the signal and/or the correspondingly applied current strength and/or the duration of the application of the voltage and/or of the current strength and/or the waveform of the voltage signal and/or the waveform of the current strength signal can be regulated or selected or changed. Here, the signal generator can ensure, for example, that the voltage applied by means of the second signal according to the invention and/or the correspondingly applied current strength and/or the duration of the application of the voltage and/or of the current strength and/or the waveform of the voltage signal and/or the waveform of the current strength signal could be selected or set as a function of the properties of the employed semiconductor material according to the invention and/or depending on the temperature and/or on the connection/the arrangement/the incorporation of a device according to the invention and/or on a memristive element connected to it, for example, in an artificial neural network and/or in another circuit, and this is done in such a way that the precondition for a change of the excited material or of the amorphous semiconductor material from a less conductive state into a more conductive state, for example, is fulfilled only within a time interval <0.1 s, preferably <0.05 s, preferably <0.025 s, preferably <0.01 s, preferably <0.005 s, preferably <0.001 s, preferably <775 μs, also preferably <500 μs, also preferably <250 μs, also preferably <200 μs, also preferably <150 μs, also preferably <100 μs, also preferably <50 μs, also preferably <20 μs, also preferably <10 μs, also preferably <5 μs, also preferably <1 μs, also preferably <0.5 μs, also preferably <500 ns, also preferably <100 ns, also preferably <50 ns, especially preferably <10 ns. Here, the properties of the excitable material or of the excitable semiconductor material employed comprise, for example, especially the excitability or the voltage threshold value and/or the change in the excitability over time or the drift of the voltage threshold value over time. Here, a shorter time interval, for example, in a processing mode, could be useful and/or could contribute to a higher processing speed or a higher data throughput rate.

The signal generator can ensure, for example, that the voltage applied by means of a first signal according to the invention and/or by means of a second signal according to the invention and/or the correspondingly applied current strength and/or the corresponding duration of the application of the voltage and/or of the current strength and/or the corresponding waveform of the voltage signal and/or the waveform of the current strength signal can be selected or set as a function of the properties of the employed excitable material or of the semiconductor material according to the invention and/or depending on the temperature and/or on the connection/the arrangement/the incorporation of a device according to the invention and/or on a memristive element connected to it, for example, in an artificial neural network and/or in another circuit, since the selection of the above-mentioned parameters can depend especially, for example, on the excitability or on the electrical excitability and/or on the change in this excitability or in this electrical excitability over time. In fact, the time interval during which the precondition is still fulfilled for a change of the excitable material or of the excitable semiconductor material that is in the excited or amorphous state from a less conductive state into a more conductive state by means of a second signal according to the invention can depend, for example, on the excitable material or on the excitable semiconductor material employed and/or on the temperature and/or on the connection/the arrangement/the incorporation of a device according to the invention and/or on a memristive element connected to it, for example, in an artificial neural network and/or in another circuit. In particular, the selection of the above-mentioned parameters, can depend, for example, on the voltage threshold value of an amorphous semiconductor material, of a phase-change material, or of a material in which a phase change can take place, and/or on the change in the voltage threshold value over time. In this context, the voltage threshold value of an amorphous semiconductor material, of a phase-change material, or of a material in which a phase change can take place can be considered as a threshold value for the excitability or electrical excitability. Especially the voltage applied by means of the second signal and/or the correspondingly applied current strength and/or the duration of the application of the voltage and/or of the current strength and/or the waveform of the voltage signal and/or the waveform of the current strength signal could be set or selected, for instance, by means of a signal generator, as a function of the properties of the excitable material or of the excitable semiconductor material employed according to the invention and/or depending on the temperature and/or on the connection/the arrangement/the incorporation of a device according to the invention and/or on a memristive element connected to it, for example, in an artificial neural network and/or in another circuit.

Moreover, the signal generator can ensure, for example, that the voltage applied by means of a first signal according to the invention and/or by means of a second signal according to the invention and/or the correspondingly applied current strength and/or the corresponding duration of the application of the voltage and/or of the current strength and/or the corresponding waveform of the voltage signal and/or the waveform of the current strength signal can be selected or set as a function of the properties of the excitable material or of the semiconductor material employed according to the invention and/or depending on the temperature and/or on the connection/the arrangement/the incorporation of a device according to the invention and/or on a memristive element connected to it, for example, in an artificial neural network and/or in another circuit, especially in order to be able to achieve a change, for example, by means of the second signal or at least by means of a portion thereof, in the resistance of a memristive element that is connected to a device according to the invention and/or a change in the resistance of a phase-change material that is employed in the device according to the invention.

In this manner, a device according to the invention comprising a memristive element that is connected to it and whose access to it is controlled by the device can be used, for instance, as an artificial synapse, wherein the weight can be readily influenced by means of a change in the resistance of a memristive element that is connected to a device according to the invention and also as a function of the time interval between two signals in order to implement an STDP behavior.

The present invention also relates to the use of at least one device according to the invention, whereby at least one device according to the invention is provided or used, for example, in an artificial neural network, especially, for instance, in an artificial synapse and/or as part of an artificial synapse and/or as an artificial synapse. Here, at least one device according to the invention can also be used to evaluate the temporal correlation between two signals arriving or applied there, in order to implement an STDP behavior or in order to change the weight of an artificial synapse or of several artificial synapses, for example, in an artificial neural network and/or in a circuit, as a function of the time interval between two signals. An artificial synapse can constitute or allow, for example, a connection between two points or two artificial neurons, especially in an artificial neural network. An artificial neural network can consist of neuromorphic hardware or can comprise appropriate hardware, and can be structured according to the example of a natural neural network or can emulate such a natural neural network.

In this manner, an STDP behavior can be readily implemented. An STDP behavior can thus be advantageously implemented, especially, for instance, even without complex additional electronics for timing the signals/impulses.

The present invention also relates to the use of at least one device according to the invention, whereby at least one device according to the invention is used especially, for instance, as an artificial synapse, for example, to change the electric resistance at certain points in a neural network, as a function of the time interval between two signals applied to or arriving at the device, whereby a change in the resistance is effectuated by a change in the resistance of a memristive element that is connected to the device according to the invention that controls access to it.

As a result, the increase or reduction in the resistance at certain points in a neural network and/or as an artificial synapse can cause the connection between certain points in a neural network and/or between certain artificial neurons to be improved or worsened by means of a change in the electric resistance of the memristive element.

A device according to the invention that comprises a memristive element and that controls access to it can thus, for example, be used as an artificial synapse in an artificial neural network, whereby the weight of an artificial synapse can be changed by changing the resistance of the memristive element.

In this context, the weight of a synapse can be increased if the connection that is made by this synapse is improved through access via a device according to the invention by reducing the resistance of a memristive element. On the other hand, the weight of a synapse can be reduced if the connection that is made by this synapse is worsened through access via a device according to the invention that controls the access by increasing the resistance of a memristive element.

The resistance of a memristive element that is connected to a device according to the invention and whose access is controlled by it can especially be reduced, for example, if the precondition is still fulfilled for a change of an excitable material or an excitable semiconductor material that is in the excited or amorphous or semi-crystalline state from a less conductive state into a more conductive state when a second signal according to the invention arrives at a device according to the invention, or if a second signal according to the invention arrives at the device according to the invention within a time interval during which the precondition is still fulfilled for a change of the excited material or of the amorphous semiconductor material that is employed in a device according to the invention into a state having a lower resistance when the second signal arrives, in spite of the change in the excitability of this material over time.

On the other hand, the resistance of a memristive element that is connected to a device according to the invention and whose access is controlled by it will also be increased if the above-mentioned precondition for a change of the excited material or of the amorphous semiconductor material is no longer fulfilled.

In this manner, a device according to the invention comprising a memristive element that is connected to it and whose access to it is controlled by the device according to the invention can be used, for instance, as an artificial synapse in which the weight can be readily influenced by means of a change in the resistance of a memristive element that is connected to a device according to the invention as a function of the time interval between two signals in order to implement an STDP behavior.

As an alternative, at least one device according to the invention can be used especially, for instance, as an artificial synapse, for example, to change the electric resistance at certain points in a neural network, as a function of the time interval between two signals applied to or arriving at the device, whereby a change in the resistance is effectuated by a change in the resistance of the excitable material or of the phase-change material that is employed in a device according to the invention.

Here, the resistance of a device according to the invention can be reduced if the precondition is still fulfilled for a change of the excitable material or of the phase-change material that is employed in it from a less conductive state into a more conductive state when a second signal according to the invention arrives at a device according to the invention, or if a second signal according to the invention arrives at the device within a time interval during which the precondition for a change is still fulfilled, in spite of the change in the excitability of this material over time.

On the other hand, the resistance of a device according to the invention can remain unchanged at a high level and/or can be increased if the precondition for a change of the excitable material or of the phase-change material from a less conductive state into a more conductive state is no longer fulfilled when a second signal according to the invention arrives at a device according to the invention, or else if a second signal according to the invention arrives at the device after the end of the time interval during which the precondition for a change is still fulfilled, in spite of the change in the excitability of this material over time.

Accordingly, a device according to the invention can be used as an artificial synapse in an artificial neural network, also especially if the device according to the invention is not connected to an autonomous memristive element. Here, the fact that the electric resistance at certain points of an artificial neural network is changed as a function of the time interval between two signals that are applied to or arriving at the device can cause the weight of the artificial synapse to change, or can cause the connection that is established by the synapse to be improved, to remain unchanged and/or to worsen.

As a result, in order to implement an STDP behavior, a device according to the invention can be used, for example, as an artificial synapse in which the weight can be readily influenced by means of a change in the resistance of a memristive element that is connected to a device according to the invention, as a function of the time interval between two signals.

The present information likewise relates to a method for the evaluation of a time interval between two excitations, wherein

a first excitation is applied to an excitable material in order to bring this material, at least partially, into an excited state,

the excitability of the excitable material that is in the excited state changes over time,

a second excitation is applied to the excitable material that is in the excited state,

a temporary change from an electrically less conductive state into an electrically more conductive state can be triggered by means of the second excitation as a function of the change in the excitability of the excitable material that is in the excited state.

The present invention relates especially, for example, to a method for the evaluation of a time interval between two signals, wherein

a first electric signal is applied to an electrically excitable semiconductor material in order to bring this semiconductor material into an amorphous state,

the electrical excitability of the semiconductor material that is in the amorphous state changes over time,

a second electric signal is applied to the semiconductor material that is in the amorphous state,

a temporary change from an electrically less conductive state into an electrically more conductive state can be triggered by means of the second electric signal as a function of the change in the excitability of the semiconductor material that is in the amorphous state.

Here, the term “change in the excitability” means, for example, the change in the further excitability after a first excitation, brought about especially by means of a first/an earlier signal. The excitability of the excited material or of the amorphous semiconductor material can change over time or as time passes.

The term “temporary” can mean not continuous, so that a temporary change and/or a temporary state can continue to exist/can be reached, for example, only in case of a continuous excitation or for the duration of an excitation, especially in case of a continuous signal or for the duration of a signal. A temporary change or a temporary state can relate, for instance, especially to at least a portion of such a material.

The first excitation or the first signal according to the invention and the second excitation or the second signal according to the invention can preferably stem, for example, from two different sources in an artificial neural network, namely, from two different artificial neurons of an artificial neural network or of the artificial neural network (the presynaptic neuron and/or the postsynaptic neuron). These two different artificial neurons can meet each other at a device according to the invention that can be used, for example, as an artificial synapse and/or as a portion of an artificial synapse in an artificial neural network or else they can be connected by a device according to the invention. Therefore, the two artificial neurons that are different from each other (presynaptic neuron and postsynaptic neuron) are connected to each other via a device according to the invention that is used as an artificial synapse and/or as part of an artificial synapse.

In this context, the first excitation or the first signal according to the invention can be generated and/or emitted, for instance, by a presynaptic artificial neuron that is connected to a device according to the invention that is used as an artificial synapse. The second excitation or the second signal according to the invention can be generated and/or emitted, for example, by a postsynaptic artificial neuron that is likewise connected to the same device according to the invention that is used as an artificial synapse. As an alternative, the first excitation or the first signal could also be generated and/or emitted by an artificial postsynaptic neuron. In this case, the second excitation or the second signal can be generated and/or emitted by the appertaining artificial presynaptic neuron.

In one embodiment of a method according to the invention, the resistance of a memristive element that is connected to a device according to the invention in such a way that it controls access to the memristive element can be increased or reduced by at least a portion of a first excitation or of a first signal and/or by a portion of a second excitation or of a second signal.

In this manner, a connection established by a device according to the invention that is connected to a memristive element and that controls access to it can be improved or worsened in order to allow its use as an artificial synapse and possibly to readily implement an STDP behavior.

The present invention also relates, for example, to a method for the evaluation of a time interval between two excitations or two signals, wherein, for instance, an excitable material or an electrically excitable semiconductor material is temporarily changed from a less conductive state into a more conductive state as triggered by means of an excitation or by means of an electric signal if the precondition for such a change is fulfilled, in spite of the change in the excitability. Whether or not the precondition for such a change is fulfilled can depend, for example, especially on the point in time of the excitation or on the point in time when the signal arrives.

However, whether or not the precondition for such a change is fulfilled can also depend, for example, on the temperature and/or on the employed first signal and/or second signal and/or on the excitable material or on the excitable semiconductor material employed.

The present invention also relates, for example, to a method for the evaluation of a time interval between two excitations or between two signals during which, for instance, the resistance of an excitable material or an electrically excitable material that is employed in a device according to the invention and that was brought, at least partially, into an excited or amorphous or semi-crystalline state by means of a first excitation or by means of a first signal can be temporarily reduced if the length of the time interval is not above a certain value. On the other hand, the resistance of the device according to the invention can remain unchanged if a value for the length of the time interval between the first signal and the second signal is exceeded. This is the case here, for example, if the second signal arrives at the device according to the invention too late after the first signal to still temporarily bring the excited material or the amorphous or semi-crystalline material from a less conductive state into a more conductive state.

The excited material or of the amorphous semiconductor material can thus temporarily changed from a less conductive state into a more conductive state, for example, only within a certain time interval. In this manner, an STDP behavior can be readily implemented.

The present invention likewise relates to a method for the evaluation of a time interval between two excitations or two signals, wherein the resistance of a memristive element that is connected to a device according to the invention and whose access is controlled by this device can be continuously reduced if the time interval between two excitations or two signals is short enough for a second excitation or a second signal to still be able to temporarily bring the excited material or the amorphous semiconductor material from an electrically less conductive state into an electrically more conductive state.

Moreover, the resistance of a memristive element that is connected to a device according to the invention and whose access is controlled by this device can be continuously increased if the time interval between two excitations or two signals is too long for a second excitation or a second signal to still be able to temporarily bring the excited material or the amorphous semiconductor material from an electrically less conductive state into an electrically more conductive state.

As an alternative, the resistance of a device according to the invention can remain at a high level or can be increased if the time interval between two excitations or two signals is too long/too great for the second excitation or the second signal to be able to temporarily bring the excited material or the amorphous semiconductor material from an electrically less conductive state into an electrically more conductive state. In this context, a change in the resistance of a memristive element can be, for example, made possible and/or simplified if the resistance of a device according to the invention is increased or remains at a high level. Thus, a change in the resistance of a memristive element can be, for example, prevented or made more difficult if the resistance of a device according to the invention is reduced. This can especially be useful if a device according to the invention and a memristive element connected to it whose access is controlled by the device are connected in parallel.

In this manner, a connection established by a device according to the invention that comprises a memristive element and that is used as an artificial synapse can be improved or worsened as a function of the time interval between a first excitation and a second excitation or between a first signal and a second signal in order to readily implement an STDP behavior.

The present invention likewise relates to a method for the evaluation of a time interval between two excitations or two signals, wherein the resistance of a phase-change material or of a material in which a phase change can take place and which is used in a device according to the invention can be continuously reduced if the time interval between two excitations or two signals is short enough for a second excitation or a second signal to still be able to temporarily bring the excited material or the amorphous semiconductor material from an electrically less conductive state into an electrically more conductive state.

The present invention likewise relates to a method for the evaluation of a time interval between two excitations or two signals, wherein the resistance of a phase-change material or of a material in which a phase change can take place and which is used in a device according to the invention can be continuously increased if the time interval between two excitations or two signals is too long for a second excitation or a second signal to still be able to temporarily bring the excited material or the amorphous semiconductor material from an electrically less conductive state into an electrically more conductive state.

In this manner, the weight of a device according to the invention that can be employed especially, for example, either as an artificial synapse or else in/with an artificial synapse can be changed, even without a memristive element that is connected to it and that is otherwise autonomous, and it can be readily influenced as a function of the time interval between two signals in order to implement an STDP behavior.

The present invention likewise relates, for instance, to a method for the evaluation of a time interval between two excitations or two signals, wherein, for example, an excitable material or an excitable semiconductor material can be, for example, a phase-change material. Owing to the rapid change between material states that is thus made possible, the signals that have to be processed can, for instance, follow each other in more rapid succession. Consequently, a high processing speed or a high data throughput rate could be achieved.

The present invention likewise relates to a method for the evaluation of a time interval between two excitations or two signals, wherein an excitation generator or a signal generator can select or set an excitation or a signal in an appropriate manner.

Here, the second excitation or the second signal can be selected or set in such a way that an excitable material or an electrically excitable semiconductor material is temporarily changed from an electrically less conductive state into an electrically more conductive state only if a given value for the time interval between the first excitation and the second excitation or the first signal and the second signal is not exceeded.

The fact that the second excitation or the second signal is selected in such a way that an excitable material or an electrically excitable semiconductor material is temporarily changed from an electrically less conductive state into an electrically more conductive state only if a given value for the time interval between the first signal and the second signal is not exceeded can mean here, for instance, that the voltage applied by means of the second excitation or by means of the second signal and/or the correspondingly applied current strength and/or the duration of the application of the voltage and/or of the current strength and/or the waveform of the voltage signal and/or the waveform of the current strength signal of the second excitation or of the second signal can be selected or set depending on the excitability of the excitable material or of the excitable semiconductor material employed and/or on the change in this excitability and/or on the temperature and/or on the connection/the arrangement/the incorporation of the device according to the invention and/or on a memristive element connected to it, for example, in an artificial neural network and/or in another circuit.

Here, the selection of the second excitation or of the second signal can depend especially, for instance, on the voltage threshold value and/or on the change in the voltage threshold value over time and/or on the temperature and/or on the connection/the arrangement/the incorporation of a device according to the invention and/or on a memristive element connected to it, for example, in an artificial neural network and/or in another circuit. The voltage threshold value of a phase-change material or a material in which a phase change can take place can be considered here as the threshold value for the electrical excitability. Here, the selection or setting of the first excitation and/or of the second excitation or of the first signal and/or of the second signal can preferably take place exactly one time for each device according to the invention and/or for a group of more than two devices according to the invention, depending on the material properties of the excitable material or of the excitable semiconductor material employed according to the invention and/or on the temperature and/or on the connection/the arrangement/the incorporation of a device according to the invention and/or on a memristive element connected to it, for example, in an artificial neural network and/or in another circuit, for example, especially by means of at least one excitation generator or signal generator that has been provided. The waveform of a first excitation and/or of a second excitation or the waveform of a first signal and/or of a second signal can be selected, for instance, as a square-wave pulse, as two or more square-wave pulses that merge into each other or that immediately follow each other with different maxima (in terms of current strength and/or voltage), as a triangular-wave pulse or as a square-wave pulse with a gradually rising and/or falling maximum. By means of a square-wave pulse with a gradually rising and/or falling maximum (in terms of current strength and/or voltage), for example, a gradual STDP behavior could be achieved in which the shorter the time interval between the two excitations or the two signals is, the greater the extent to which the resistance of an artificial synapse comprising a device according to the invention is reduced, and/or the longer the time interval between the two excitations or the two signals is, the greater the extent to which the resistance of said artificial synapse is increased. In contrast to this, the use of a square-wave pulse can cause an STDP behavior to be achieved in which the resistance of an artificial synapse comprising a device according to the invention is reduced if the time interval between two excitations or two signals is below a given value for the time interval, and/or the resistance of an artificial synapse comprising a device according to the invention is increased if the time interval between two excitations or two signals is above a given value for the time interval.

The present invention likewise relates to a method for the evaluation of a time interval between two excitations or two signals, wherein the temperature can be used to influence the change in the excitability of the excitable material or of the excitable semiconductor material that is in the excited or amorphous state. Here, the change in the excitability can be, for example, accelerated or slowed down. In this manner, it is possible to vary or change the time interval between two excitations or two signals during which a change can be achieved in the weight of a device according to the invention used as an artificial synapse or an artificial synapse comprising a device according to the invention.

As a result, the learning ability of an artificial neural network comprising at least one device according to the invention could be influenced or changed.

The present invention likewise relates to an artificial neural network having a plurality of artificial neurons connected to each other and/or having a plurality of artificial synapses connected to each other, wherein the network comprises at least one device according to the invention and/or is operated employing a method according to the invention.

In one embodiment, at least one heating element and/or cooling element can be provided for the entire neural network and/or for certain areas thereof. In this manner, the learning ability of the entire artificial neural network and/or certain areas thereof can be influenced and/or could even be brought from a learning mode into a processing mode and/or vice versa.

In another embodiment, the artificial neural network according to the invention can also comprise at least one excitation generator or signal generator that can set or select the first excitation and/or the second excitation or the first signal and/or the second signal according to the invention in a suitable manner, for example, depending on the material properties of the excitable material or of the excitable semiconductor material employed, on a value that seems useful or desirable for the maximum time interval during which a correlation between two arriving signals should still be recognized, on the temperature and/or on the connection/the arrangement/the incorporation of a device according to the invention and/or on a memristive element connected to it, for example, in an artificial neural network and/or in another circuit. Here, the material properties of the excitable material or of the excitable semiconductor material employed comprise, for instance, especially the excitability or the voltage threshold value and/or the change in the excitability over time or else the drift of the voltage threshold value over time.

### DESCRIPTION OF THE FIGURES

By way of example, in FIG. 1, the drift of the voltage threshold value (Vₛ in volts) over time (in seconds) after a first signal is shown for a device according to the invention comprising Ge₂Sb₂Te₅. This drift constitutes the change in the excitability of this material that is in the excited or amorphous state. Here, Ge₂Sb₂Te₅ is an excitable material or an excitable semiconductor material and especially an electrically excitable semiconductor material. This material is used in a device according to the invention. This material was continuously brought, at least partially, into an amorphous or semi-crystalline state or into an excited state by means of a first short signal at a voltage of 3 volts. In this manner, especially the area immediately adjoining an electrode used for applying a signal was brought into an amorphous or semi-crystalline state. In this excited state, the voltage threshold value increases over time, going from 1.4 volts 0.001 seconds after the first signal to 1.8 volts 10 seconds after the first signal.

The resistance of the Ge₂Sb₂Te₅ material employed in a device according to the invention can be temporarily reduced by means of a second signal when a given value for the time interval between the first signal and the second signal is not exceeded. For this purpose, for example, a second signal having a voltage of 1.5 volts can be selected or set. In this context, the voltage threshold value that changes over time reaches a value of 1.5 volts 0.01 seconds after the first signal. In this case, the resistance of the Ge₂Sb₂Te₅ material employed in a device according to the invention can be temporarily reduced if a value for the length of the time interval between the first signal and the second signal is not above 0.01 seconds, since, during this time interval, the voltage threshold value is still reached by the second signal. Therefore, the second signal has to arrive earlier than 0.01 seconds after the first signal so that the precondition for a change to a more conductive state can still be fulfilled.

On the other hand, the resistance of the device according to the invention can remain unchanged if a given value for the time interval between the first signal and the second signal is exceeded. This is the case here, for example, if the second signal only arrives at the device according to the invention later than 0.01 seconds after the first signal. In this case, the second signal having a voltage of 1.5 volts can no longer trigger a temporary change to a more conductive state since the voltage threshold value is now no longer reached.

By way of an example, FIG. 2 shows an arrangement in which a device (1) according to the invention can control access to a memristive element (2) connected to it via/by means of a transistor (3), whereby the resistance of a transistor (3) and/or the portion/current of a second signal that is allowed to pass through via/by means of the transistor (3) can be changed as a function of a device (1) according to the invention or as a function of the portion/current of a second signal (current strength and/or voltage and/or duration) that is allowed to pass through via/by means of the device (1) according to the invention. The transistor (3) can also be configured in such a way that at least one portion of each signal is allowed to pass through (“leaky transistor”).

Here, a change in the resistance of a memristive element (2) can be, for example, made possible and/or simplified by a change in the resistance of the transistor (3) if, for instance, the resistance of a device (1) according to the invention is temporarily reduced, especially if the time interval between a first signal—which can come, for example, from direction (4) (which can be the direction of an artificial presynaptic neuron)—and a second signal—which can come from direction (5) (which can be the direction of an artificial postsynaptic neuron)—is below a certain value, here especially, for instance, below 0.01 seconds. In this context, a temporary reduction in the device (1) according to the invention leads to a temporary reduction in the resistance of the transistor (3). As a result, the resistance of the memristive element (2) can be changed or reduced with the second signal or with a portion thereof. The portion of the second signal (current strength and/or voltage and/or duration) that is allowed to pass through by means of the transistor (3) is thus available to change the resistance of the memristive element (2). Since the transistor (3) that is upstream from the memristive element (2) could be at least partially permeable to each signal, every signal is influenced by the resistance of the memristive element (2). An improvement in a connection between points (4) and (5) can thus be effectuated by a reduction in the resistance of the memristive element (2). The two lines at (4) can both be connected to one/the same artificial presynaptic neuron. The two lines at (5) can, in turn, both be connected to one/the same artificial postsynaptic neuron. As an alternative, the two lines at (4) and (5) could also each be only one line at (4) and (5) respectively. The connection between these neurons can be improved in this manner.

On the other hand, a worsening of such a connection can occur due to an increase in the resistance of the memristive element (2). This is especially the case here, for example, if the second signal arrives at the device (1) according to the invention later than 0.01 seconds after the first signal. In this case, the resistance of the device (1) according to the invention is no longer temporarily reduced and the portion of the second signal that is allowed to pass through by means of the transistor (3) is not sufficient to reduce the resistance of the memristive element (2) (for example, by means of a long square-wave pulse at a lower voltage, which can be provided at the beginning of the second signal), but rather only to increase the resistance of the element (2), if applicable (for example, by a short square-wave pulse having a higher voltage, which can be provided immediately after the longer pulse at the end of the second signal). For this purpose, the memristive element and/or the material employed therein can be selected in an appropriate manner. An STDP behavior can be implemented in this manner.

FIG. 3 shows the rise of the voltage threshold value (in volts) over time (in seconds) after a first signal (a so-called reset pulse) in a lateral phase-change cell consisting of amorphous AgIn-Sb₂Te. Postsynaptic signals with a fixed voltage value (e.g. 1.1 volts) can induce a switching of the cell by exceeding the voltage threshold value only during a limited window of time after the last presynaptic impulse. Only in this case does the amorphous access element allow the flow of significant currents through the memristive element in order to potentiate the synaptic weight (which is a measure of the strength of a connection between two (synaptic) nodes). The inserted Figure (a) shows the STDP that can be implemented with the electrical circuit shown in Figure (b).

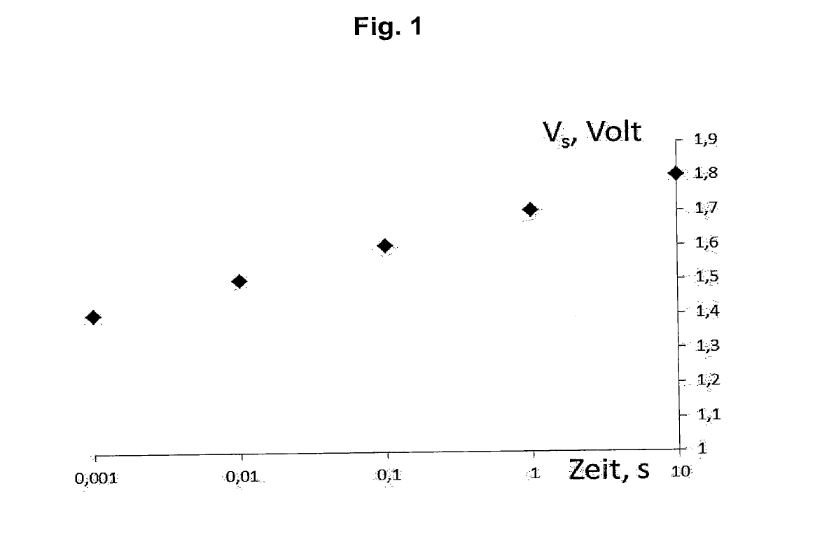

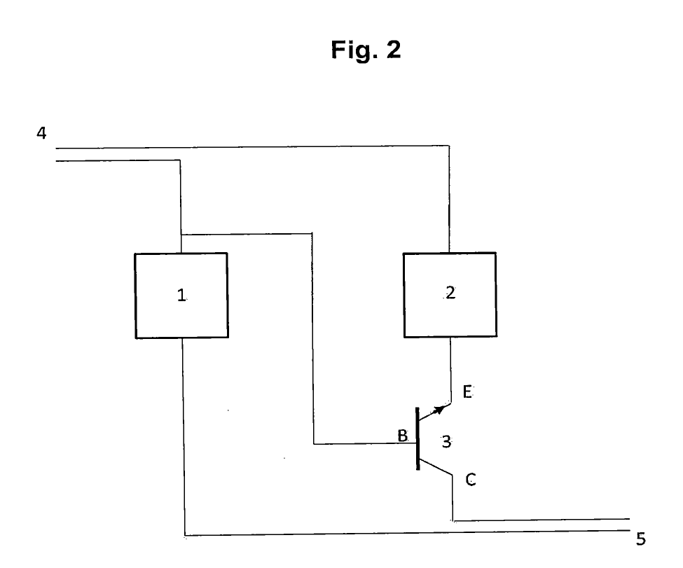

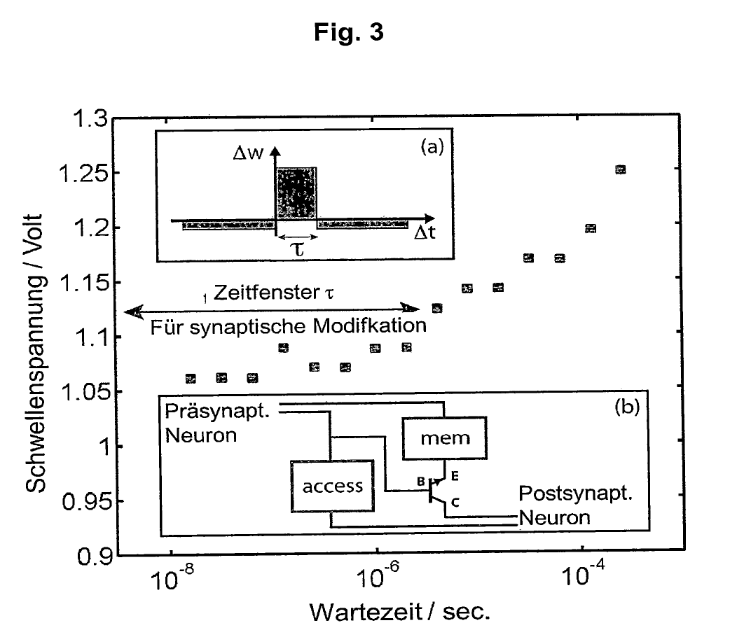

1-14. (canceled)

15. A method for the evaluation of a time interval between two excitations, characterized in that
a first excitation is applied to an excitable semiconductor material in order to bring this material into an excited amorphous state,
the excitability of the excitable semiconductor material that is in the excited amorphous state decreases over time, resulting in a voltage threshold value that increases over time and that marks the transition between poor conductance at low voltages and good conductance at high voltages,
a second excitation is applied to the excitable semiconductor material that is in the excited amorphous state, whereby the second excitation is selected in such a way that the excitable semiconductor material is temporarily changed from an electrically less conductive state into an electrically more conductive state only if a given value for the time interval between the first excitation and the second excitation is not exceeded,
a temporary change from an electrically less conductive state into an electrically more conductive state is triggered by means of the second excitation as a function of the change in the excitability of the excitable semiconductor material that is in the excited amorphous state,
whereby the evaluation of the time interval between two excitations is effectuated in that the probability of being able to trigger a change by means of a second excitation decreases over time, corresponding to the electrical excitability that decreases over time.

16. The method for the evaluation of a time interval between two excitations according to claim 15, characterized in that
the resistance of a memristive element that is connected to a device according to the invention and whose access is controlled by this device is continuously reduced if the time interval between two excitations or two signals is short enough for a second excitation or a second signal to still be able to temporarily bring the excited amorphous semiconductor material from an electrically less conductive state into an electrically more conductive state, or as an alternative, in that the resistance of a memristive element that is connected to a device according to the invention and whose access is controlled by this device is continuously increased if the time interval between two excitations or two signals is too long for a second excitation or a second signal to still temporarily bring the excited amorphous semiconductor material from an electrically less conductive state into an electrically more conductive state.

17. The method for the evaluation of a time interval between two signals according to claim 15, characterized in that
the resistance of a phase-change material, as an electrically excitable semiconductor material that is used in a device according to the invention, is continuously reduced if the time interval between two excitations or two signals is short enough for a second excitation or a second signal to still temporarily bring the excited amorphous semiconductor material from an electrically less conductive state into an electrically more conductive state, or as an alternative, in that the resistance of a phase-change material, as an electrically excitable semiconductor material that is used in a device according to the invention, is continuously increased if the time interval between two excitations or two signals is too long for a second excitation or a second signal to still be able to temporarily bring the excited amorphous semiconductor material from an electrically less conductive state into an electrically more conductive state.

18. The method for the evaluation of a time interval between two signals according to claim 15, characterized in that
an excitation generator or a signal generator selects or sets at least one excitation or at least one signal in an appropriate manner, or as an alternative, in that an increase or reduction in the temperature is used to influence the change in the excitability of the excitable semiconductor material that is in the excited amorphous state.

19. The use of a device for the method for the evaluation of a time interval between two excitations according to claim 15, characterized in that
the device comprises an electrically excitable semiconductor material that is brought into an excited amorphous state by means of a first signal, whereby the electrical excitability of the semiconductor material that is in the excited amorphous state changes over time, and the semiconductor material that is in this excited amorphous state is caused to change from an electrically less conductive state to an electrically more conductive state by means of a second signal, whereby moreover, the change takes place as a function of the change in the excitability of the semiconductor material that is in the excited amorphous state.

20. The use of the device according to claim 19, characterized in that
the electrically excitable semiconductor material comprises at least one element from Groups III and/or IV A and/or V A and/or VI A of the periodic table and/or at least one chalcogenide and/or a modified chalcogenide.

21. The use of the device according to claim 19, characterized in that
the electrically excitable semiconductor material is a phase-change material that can be excited, for instance, by means of an electric voltage, whereby the phase-change material that is in the excited amorphous state can be excited by means of a voltage that is above a voltage threshold value, whereby the voltage threshold value of the phase-change material that is in the excited amorphous state, and thus the electrical excitability of this material, changes over time.

22. The use of the device according to claim 19, characterized in that
the device comprises at least one heating element and/or cooling element in order to change the excitability of the employed excitable material as a function of the temperature, and/or it comprises at least one excitation generator or signal generator.

23. The use of the device according to claim 19, characterized in that
at least one device according to claim 19 is provided or used in an artificial neural network and/or in an artificial synapse and/or as part of an artificial synapse and/or as an artificial synapse.

24. The use of the device according to claim 23, characterized in that
at least one device according to claim 19 is used as an artificial synapse to change the electric resistance at certain points in a neural network, as a function of the time interval between two signals applied to or arriving at the device, whereby a change in the resistance is effectuated by a change in the resistance of a memristive element that is connected to the device according to the invention that controls access to this memristive element.

25. The use of a device according to claim 23, characterized in that
the device is used, especially, for instance, as an artificial synapse to change the electric resistance at certain points in a neural network as a function of the time interval between two signals applied to or arriving at the device, whereby a change in the resistance is effectuated by a change in the resistance of the excitable semiconductor material or of the phase-change material that is employed in a device according to the invention.

26. An artificial neural network having a plurality of artificial neurons connected to each other, characterized in that
it is operated using a device according to claim 23.

27. An artificial neural network having a plurality of artificial neurons connected to each other according to claim 26, characterized in that
it comprises at least one heating element and/or cooling element in order to change the excitability of the employed excitable material as a function of the temperature, and/or it comprises at least one excitation generator or signal generator.
